(19) United States
(12) Patent Application Publication
(10) Pub. No.: US 2011/0159307 A1
(43) Pub. Date: Jun. 30, 2011

(54) Method for Gluing Two Plastic Surfaces Together

(75) Inventors: Marc Husemann, Hamburg (DE); Markus Brodbeck, Hamburg (DE)

(73) Assignee: TEASA SE, Hamburg (DE)

(21) Appl. No.: 12/996,292

(22) PCT Filed: Aug. 26, 2009
(86) PCT No.: PCT/EP2009/060992

§ 371 Date: Jan. 31, 2011

(30) Foreign Application Priority Data
Sep. 11, 2008 (DE) 10 2008 046 871.1

(51) Int. Cl. B32B 27/08; B32B 7/12; C09J 4/00; C09J 175/04; C09J 167/00; C09J 163/00; C08L 61/14

(52) U.S. Cl. 428/474.4; 156/327; 156/331.7; 156/330.9; 156/334; 156/330; 156/335; 428/480

(57) ABSTRACT

A method glues two plastic surfaces together via an adhesion produced by a heat-activatable adhesive. An adhesive, which is used as a heat-activatable adhesive, is based on i) at least one thermoplastic having a softening temperature or melting temperature in the region of between 90 and 120° C. At least one of the plastic surfaces that is to be glued is part of the substrate having a heat conductivity that is high enough to transfer the activation energy necessary for the adhesion of the heat-activatable adhesive

This application is a 371 of PCT/EP2009/060992 filed Aug. 26, 2009, which claims priority of German application no. 10 2008 046 871.1 filed Sep. 11, 2008.

The invention relates to a heat-activatable adhesive mass with high repulsion resistance in particular at temperatures up to +85° C., and also to the use thereof in plastics/plastics adhesive bonds in consumer-electronics components.

Double-sided pressure-sensitive adhesive tapes are usually used for the adhesive bonding of plastics components in consumer-electronics devices. The adhesive forces required for this purpose are sufficient for fixing and fastening. However, the requirements placed upon portable consumer-electronics items are becoming ever more stringent. Firstly, said items are becoming ever smaller, and the adhesive bonding areas are therefore also becoming smaller. Secondly, the adhesive bonding has to comply with additional requirements since portable items are used within a relatively large temperature range and moreover can be exposed to mechanical load (impacts, falls, etc.). There is also a trend toward the use of flexible circuit boards. An advantage of these in comparison with existing solid circuit boards is that they are markedly flatter and can combine a wide variety of flexible electrical components with one another. By way of example, FPCs (flexible printed circuits; flexible circuit boards) are often used for driving displays, and these are flexible in particular in the case of notebooks and also in the case of foldable cell phones. Flexible circuit boards are also used to drive camera lenses or for backlighting units for LCD displays (liquid crystal displays, liquid crystal data displays). This trend increases design freedom, since an ever greater number of components can be designed flexibly, while nevertheless retaining electrical connectability. However, the use of flexible circuit boards also requires new adhesive-tape solutions, since flexible circuit boards are also frequently partially fixed within the casing. Pressure-sensitive adhesive masses or double-sided pressure-sensitive adhesive tapes are usually used for this purpose. However, the requirements here are relatively stringent, since the flexural stiffness of the flexible circuit board produces a constant repulsion force, which must be compensated by the pressure-sensitive adhesive mass. Another factor is that consumer-electronics devices frequently are also subject to a test involving changing climatic conditions, with the aim of simulating climatic effects. The usual temperature range covered here is from −40° C. to +85° C. While relatively low temperatures pose no problem, since the pressure-sensitive adhesive mass hardens at these temperatures and internal strength therefore rises, high temperatures pose a particular problem, since at these temperatures the pressure-sensitive adhesive masses become ever more flowable, and lose internal strength, and the pressure-sensitive adhesive masses or pressure-sensitive adhesive tapes undergo cohesive fracture when exposed to the repulsion force. In spite of this difficult environment, a wide variety of pressure-sensitive adhesive tapes have already been developed. By way of example, the products 5606R and 5608R from Nitto Denko are available for this purpose. There is also the possibility of increasing the layer thickness of the pressure-sensitive adhesive mass or of the pressure-sensitive adhesive tape, since as weight per unit area rises adhesion also rises.

Another possibility for the adhesive bonding of components in the consumer-electronics sector is provided by heat-activatable foils. Heat-activatable adhesive masses can be divided into two categories:
a) thermoplastic heat-activatable foils
b) reactive heat-activatable foils.

Heat-activatable foils exhibit particularly high adhesive bond strength, but require heat for activation. They are therefore generally used for adhesive bonds between metal and metal or between metal and plastic. The metal side here permits introduction of the heat needed for the activation process. In the case of adhesive bonds between plastic and plastic this is not possible, since plastics act as thermal barrier and usually deform before the necessary heat reaches the heat-activatable adhesive mass.

These explanations show that there is still a requirement for an adhesive mass or an adhesive tape which can be used for the adhesive bonding of FPCs and which can absorb the repulsion force, and specifically even when layer thicknesses are below 100 μm, since consumer-electronics devices are becoming ever smaller and thinner.

In the light of said prior art, the invention is based on the object of providing an adhesive foil for the fastening of flexible circuit boards on plastics components for portable consumer-electronics items, where the foil in particular
a) can be used at from −40 to +85° C. and withstands the repulsion force of the flexible circuit board within this temperature range,
b) features bond strengths greater than 15 N/cm on polyimide, and
c) can be activated by heat, without any surface damage to the plastics requiring adhesive bonding.

The invention achieves the object via a process for the adhesive bonding of two plastics surfaces with use of an adhesive mass or of an adhesive foil, comprising at least one heat-activatable adhesive mass.

At least one of the plastics surfaces here should very preferably belong to a substrate which has a thermal conductivity sufficiently large to transmit the activation energy needed for the adhesive bonding process to the heat-activatable adhesive mass.

It is very preferable that the adhesive mass is based on
i) at least one thermoplastic with a softening point or melting point in the range from 90 to 120° C.,
ii) optionally up to 20% by weight of at least one tackifying resin,
   and/or
iii) optionally up to 30% by weight of one or more reactive resins, i.e. resins which are capable of reacting with themselves, with other reactive resins, and/or with the thermoplastic.

In one advantageous embodiment, the adhesive mass is restricted to the abovementioned constituents, but it can also be advantageous in the invention that it comprises further constituents.

At least one of the plastics surfaces must belong to a substrate which has a thermal conductivity sufficiently large to transmit the activation energy needed for the adhesive bonding process to the heat-activatable adhesive mass.

Thermoplastics are the compounds defined in Römpp (on-line version; 2008 edition, document code RD-20-01271).

The adhesive mass should very preferably have a crossover point (where storage modulus and loss modulus are identical) above 100° C. and below 125° C., measured by test method C (see experimental section). The curves of storage modulus G′ and loss modulus G″ intersect at the crossover point; this can be interpreted in physical terms as transition from elastic behavior to viscous behavior.

In one preferred design, thermoplastic materials are used which by virtue of their melting achieve good wetting in relation to the plastics surfaces. The following polymers are particularly preferably used here, but this list does not claim to be exhaustive: polyurethanes, polyesters, polyamides, ethylene-vinyl acetates, copolyamides, copolyesters, and polyolefins.

Examples of polyolefins are polyethylenes, polypropenes, polybutenes, polyhexenes, and copolymers of polyethylene, polypropene, polybutene, or polyhexene. Degussa supplies various polyolefins with trademark Vestoplast™, and a distinction is made here between propene-rich grades and butene-rich grades.

Polyamides and copolyamides are another preferred class of substance used. Polyamides or copolyamides can also be used in the form of a mixture. Polyamides or copolyamides are usually based on dicarboxylic acid and on diamines, being produced by way of polycondensation reactions. In order to achieve the melting range demanded, dicarboxylic acids preferably used are adipic acid, azelaic acid, sebacic acid, or dimer fatty acid. The abovementioned dicarboxylic acids can also be combined with one another. Preferred diamines used are ethylenediamine, hexamethylenediamine, 2,2,4-trimethylhexamethylenediamine, piperazine, or isophoronediamine. Here again, various diamines can be combined with one another. By way of example, polyamides and copolyamides are commercially available with trademark Platamid® from Arkema or with trademark Vestamelt® from Evonik Degussa.

Polyesters and copolyesters are another preferred class of substance used. Polyesters or copolyesters are based on dicarboxylic acid and diols, which are then reacted in a polycondensation reaction. In order to reach the preferred range of activation, it is particularly preferable that the dicarboxylic acids used comprise phthalic acid, isophthalic acid, terephthalic acid, or adipic acid. The abovementioned dicarboxylic acids can also be combined with one another. The diols used particularly preferably comprise 1,2-ethanediol, 1,4-butanediol, neopentyl glycol, 1,6-hexanediol, cyclohexanedimethanol, or diethylene glycol. The abovementioned diols can also be combined with one another. By way of example, copolyesters are available commercially with trademark Dynapol® S from Evonik.

In order to achieve the desired static glass transition temperature T_{G,A} or the melting point T_{M,A}, the monomers used, and also the amounts of these, are again preferably selected here in such a way that the Fox equation (E1) gives the desired temperature.

In order to control the glass transition temperature it is possible to vary not only the monomer and, respectively, comonomer constitution but also the molecular weight. In order to adjust to low static glass transition temperature T_{G,A} or melting point T_{M,A}, polymers of moderate or low molecular weight are used. It is also possible to mix low-molecular-weight and high-molecular-weight polymers with one another. Particularly preferred systems used polyethylenes, polypropylenes, polybutenes, polyhexenes, or copolymers of polyethylene, polypropene, polybutene, or polyhexene.

In order to optimize technical adhesive properties and/or activation range of the thermoplastic, it is possible to add tackifying resins or reactive resins.

Tackifying resins that can be used for addition are, without exception, any of the previously known tackifying resins described in the literature. Representative materials that may be mentioned are the pinene resins, indene resins, and kolophony resins, and their disproportionated, hydrogenated, polymerized, and esterified derivatives and salts, the aliphatic and aromatic hydrocarbon resins, terpene resins and terpene-phenolic resins, and also C5 hydrocarbon resins, C9 hydrocarbon resins, and other hydrocarbon resins. It is possible to use any desired combinations of these and other resins in order to adjust the properties of the resultant adhesive mass as desired. In general terms, it is possible to use any of the resins that are compatible (soluble) with the corresponding thermoplastic, and in particular reference may be made to all of the aliphatic, aromatic, and alkylaromatic hydrocarbon resins, hydrocarbon resins based on pure monomers, hydrogenated hydrocarbon resins, functional hydrocarbon resins, and also natural resins. Explicit reference is made to the description of the available knowledge in “Handbook of Pressure Sensitive Adhesive Technology” by Donatas Satas (van Nostrand, 1989).

Examples of suitable reactive resins are phenolic resins, epoxy resins, melamine resins, resins having isocyanate functions, and mixtures of the abovementioned resins. It is also possible, in combination with the reactive systems, to add a wide variety of other resins, filler materials, catalysts, antioxidants, etc.

One very preferred group consists of epoxy resins. The molar mass of the epoxy resins varies from 100 g/mol to at most 10 000 g/mol for polymeric epoxy resins.

The epoxy resins encompass by way of example the reaction product of bisphenol A and epichlorohydrin, the reaction product of phenol and formaldehyde (novolak resins) and epichlorohydrin, and glycidyl ester, and the reaction product of epichlorohydrin and p-aminophenol.

Examples of preferred commercial examples are Araldite™ 6010, CY-281™ ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical, and HPT™ 1071, HPT™ 1079, likewise from Shell Chemical.

Examples of commercial aliphatic epoxy resins are vinylcyclohexane dioxides, such as ERL-4206, ERL-4221, ERL 4201, ERL-4289 and ERL-0400, from Union Carbide Corp.

Examples of novolak resins that can be used are Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNipon Ink Chemistry, and Epicote™ 152 from Shell Chemical.

Reactive resins used can also comprise melamine resins, e.g. Cymel™ 327 and 323 from Cytec.

Reactive resins used can also comprise terpene-phenolic resins, e.g. NIREZ™ 2019 from Arizona Chemical.

Reactive resins used can also comprise phenolic resins, e.g. YP 50 from Toto Kasei, PKHC from Union Carbide Corp., and BKR 2620 from Showa Union Gosei Corp.

Reactive resins used can also comprise polyisocyanates, e.g. Coronate™ L from Nippon Polyurethan Ind., Desmodur™ N3300, and Mondur™ 489 from Bayer.

In order to accelerate the reaction between the two components, it is also possible to add crosslinking agents and accelerators to the mixture.

Examples of suitable accelerators are imidazoles, available commercially as 2M7, 2E4MN, 2PZ-CN, 2PZ-CNS, P0505, L07N from Shikoku Chem. Corp., and Curezol 2MZ from Air Products.

It is also possible to use amines, in particular tertiary amines, for acceleration.

### Production Process

The heat-activatable adhesive mass is provided on a release paper or on a release foil, for further processing and for adhesive bonding.

The coating process can take place from solution or from the melt. In the case of coating from solution—as is conventional in the processing of adhesive masses from solution—operations preferably use doctoring technology, and it is possible here to use any of the doctoring techniques known to the person skilled in the art. For application from the melt—if the polymer is present in solution—the solvent is preferably drawn off in a vented extruder under reduced pressure, and by way of example single- or twin-screw extruders can be used for this purpose, where these preferably remove the solvent by distillation in different or identical vacuum sections, and have feed-preheating. Coating then takes place by way of a melt die or an extrusion die, and the adhesive film is, if appropriate, stretched in order to achieve the ideal coating thickness. The resins can be mixed by using a kneader or a twin-screw extruder for the mixing process.

Temporary backing materials used for the adhesive mass comprise the conventional materials familiar to the person skilled in the art, examples being foils (polyester, PET, PE, PP, BOPP, PVC, polyimide), and also release papers (glassines, HDPE, LDPE). The backing materials should have a release layer. In one very preferred design of the invention, the release layer is composed of a silicone release coating or of a fluorinated release coating.

The process of the invention has excellent suitability for the adhesive bonding of flexible circuit boards, in particular in plastics casings of electronic components or devices. The flexible circuit board here has a thermal conductivity sufficiently large to transmit the activation energy needed for the adhesive bonding process to the heat-activatable adhesive mass.

### BRIEF DESCRIPTION OF DRAWINGS

FIG. 1 illustrates a product structure in an embodiment of the present invention.

FIG. 2 illustrates a product structure in an embodiment of the present invention.

FIG. 3 shows an example of the adhesive bonding of a flexible circuit board in an embodiment of the present invention.

### PRODUCT STRUCTURES

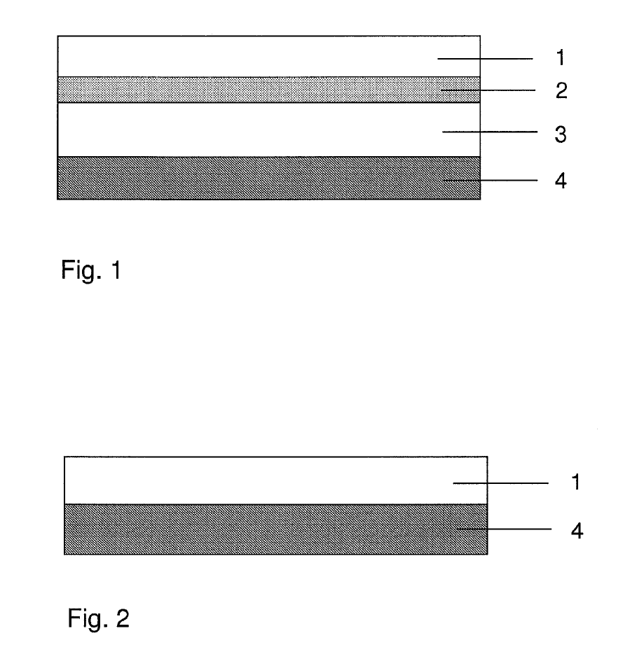

The design of the heat-activatable foils is preferably as shown in FIG. 1, where:
1=heat-activatable adhesive mass
2=backing material
3=heat-activatable adhesive mass
4=temporary backing.

The product structure shown in FIG. 1 encompasses bilateral coating of the heat-activatable adhesive mass (1, 3) on a backing material (2). The entire composite is preferably protected by at least one temporary backing (4) in order to permit unwinding of the heat-activatable adhesive masses from the roll. In another embodiment, both adhesive-mass sides (1, 3) are protectively covered with a temporary backing (not shown here). In another possibility, backing material (2) has been provided with one or more functional coatings (for example primers, adhesion promoters etc.). The adhesive-mass layers on the two sides of the backing material (2) can have identical properties; it is also possible, however, that the two adhesive-mass layers are different, in particular in respect of their chemical constitutions and/or thicknesses.

The amount of adhesive mass applied per side is preferably from 5 to 250 g/m².

The product structure shown in FIG. 2 encompasses monolateral coating of the heat-activatable adhesive mass on a temporary backing. The meaning of the reference numerals here is the same as in FIG. 1 (1=heat-activatable adhesive mass, 4=temporary backing). The heat-activatable adhesive mass (1) is preferably protectively covered with at least one temporary backing (4), in order to permit unwinding of the adhesive tape and, respectively, improve punching performance. In another embodiment, both sides are protectively covered by a temporary backing (not shown here). The amount of adhesive mass applied is preferably from 5 to 250 g/m².

Backing material that can be used here comprises the usual materials familiar to the person skilled in the art, examples being foils (polyester, PET, PE, PP, BOPP, PVC, polyimide, polymethacrylate, PEN, PVB, PVF, polyamide), nonwovens, foams, textiles, and textile foils.

### Use:

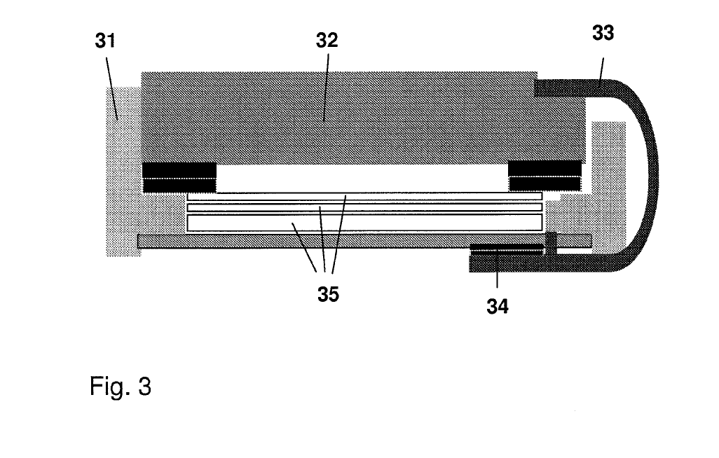

Flexible circuit boards are found in a wide variety of electronic devices, examples being cell phones, automobile radios, computers, etc. They are generally composed of layers of copper or aluminum (electrical conductors) and polyimide (electrical insulator). However, other plastics are also used as electrical insulator, examples being polyethylene naphthalate (PEN) and Liquid Crystal Polymers (LCPs). Because there is connection between the flexible electrical components, they have to be designed flexibly. However, the fact that a plurality of electrical components always have to be connected to one another causes an increase in the power level required from the flexible circuit boards, and this results in multilayer embodiments. The layer thickness of the flexible circuit board can therefore vary from 50 μm to 500 μm. Since the flexible circuit board is composed of a composite made of insulator and of electrical conductor, and the two materials have different properties, flexible circuit boards have relatively high flexural stiffness. This can be further increased by added components, e.g. ICs, or by partial reinforcement. In order then to avoid uncontrolled movements, or in order to minimize space requirement, flexible circuit boards are adhesive-bonded within the casing of electronic devices. There are generally various plastics available as materials for adhesive bonding here, examples very frequently used being polycarbonates (PC), ABS, ABS/PC blends, polyamides, glassfiber-reinforced polyamides, polyether sulfones, polystyrene, or the like. However, other substrates that can be used, even if not for the purposes of the invention, are glass and metals, e.g. aluminum or stainless steel. One typical use is represented by the adhesive bonding of flexible circuit boards on the backlighting of LCD displays, as shown in FIG. 3. The tight curve produces a constant bending force, which must be absorbed by the heat-activatable adhesive mass. Flexible circuit boards used in electronic components usually have a bending angle of at least 90°, in particular of 180°.

FIG. 3 shows an example of the adhesive bonding of a flexible circuit board by a heat-activatable adhesive mass, where the bending angle of the flexible circuit board is 180°.

### Key:

31=casing for backlighting
32=LCD panel
33=flexible circuit board
34=heat-activatable adhesive mass or heat-activatable adhesive tape (use of the invention)
35=optical films.

Another factor that has to be taken into account is that the electronic devices frequently have exposure to changing climatic conditions. This means that in the extreme case the bond strength is sufficient to avoid separation of the flexible circuit board even at 85° C.

The heat-activatable foil should moreover be capable of processing within relatively narrow processing latitude, in order to ensure firstly that there is sufficiently high residual stiffness at 85° C. but secondly heat-activation is nevertheless possible. The substrates requiring adhesive bonding are frequently only heat-resistant up to 130° C. Another factor that has to be taken into account is that electronic components have already been added to the flexible circuit boards, and these components are likewise heat-sensitive.

This distinguishes the process from, for example, the adhesive bonding of stiffening materials for partial stiffening purposes, where this process actually takes place during the process of production of the flexible circuit board. Finally, another factor that has to be taken into account is that processing latitude is subject to restriction by virtue of the large numbers of units, i.e. the heat has to be introduced relatively quickly.

### Adhesive Bonding:

### Prelamination

Punched-out sections of the heat-activatable adhesive mass are usually produced, and these are usually placed on the plastics part. In the simplest case, the punched-out section is placed on the plastics part manually, e.g. by using tweezers. The shape of the punched-out section can vary. It can also be necessary, for design-related reasons, to use full-surface-area punched-out sections. In another embodiment, the heat-activatable punched-out adhesive-tape section is treated, after manual positioning, with a heat source, e.g. in the simplest case by using a smoothing iron. This increases the adhesion to the plastic. To this end it is also advantageous that the punched-out section still has a temporary backing.

In the prior art, adhesive bonds are usually achieved on metal substrates. For this, the metal part is first placed on the heat-activatable punched-out adhesive-tape section. The placing process takes place on the open side. The reverse side still has the temporary backing. A heat source is then used to introduce heat through the metal into the heat-activatable adhesive tape. The adhesive tape thus becomes tacky and adheres more strongly on the metal than on the temporary backing.

The heat dose for the process of the invention must be appropriate. For thermoplastic adhesive masses, the softening point must be reached, in order that the punched-out adhesive-tape section begins to adhere. In one preferred design, a heated press is used to introduce the heat. The ram of the heated press has been manufactured from, for example, aluminum, brass, or bronze, and assumes the external shape of the punched-out section. The ram can moreover have design features aimed at, for example, avoiding partial heat damage. The pressure and the heat are introduced with maximum uniformity. Pressure, temperature, and time are adjusted and varied appropriately for the materials (metal, metal thickness, nature of heat-activatable foil).

The usual processing latitude for the prelamination process is from 1.5 to 10 seconds of activation time, from 1.5 bar to 5 bar of application pressure, and a heated-ram temperature of from 100° C. to 150° C.

### Adhesive Bonding of Substrates

The process of adhesive bonding between the flexible circuit board and the plastics part is preferably carried out with use of a heated press. The heat here is preferably introduced from the side of the flexible circuit board, since this generally has better thermal conductivity.

Pressure and heat are generally applied simultaneously. This is achieved via a heated ram, which is composed of a material with good thermal conductivity. Examples of usual materials are copper, brass, bronze, and aluminum. However, it is also possible to use other alloys. The heated-press ram should moreover preferably assume the shape of the upper side of the adhesive bonding area. This shape can in turn be two-dimensional or three-dimensional. The pressure is usually applied by way of a pressure cylinder. However, the application method does not necessarily have to involve air pressure. Examples of other possibilities are hydraulic press apparatuses or electromechanical apparatuses (spindles, control drives, or actuators). It can moreover be advantageous to introduce pressure and heat repeatedly in order, for example, to increase process throughput via series connection or a rotational principle. In this case it is not necessary that all of the heated-press rams are operated with identical temperature and/or identical pressure. Another possibility is that the contact time is different—although this is not always advantageous. It can moreover also be advantageous, in a final process step, to introduce only pressure, by using a press ram that is cooled, or that is cooled to room temperature.

The processing times are usually from 2.5 to 15 s per press-ram step, or more preferably at most 5 s. It can moreover also be necessary to vary the pressure. Very high pressures can cause displacement of the heat-activatable foil. It is generally desirable to minimize this. Suitable pressures are from 1.5 to 10 bar, based on the adhesive bonding area. Here again, the stability of the materials has a major effect on the pressure to be selected, as also has the rheology of the heat-activatable foil.

### EXPERIMENTAL SECTION

### Test Methods

### Repulsion Test A

A polyimide foil of thickness 100 μm is cut out to dimensions of 10 cm×1 cm, as replacement for a flexible circuit board. One of the ends of the polyimide foil is then adhesive-bonded to a polycarbonate (thickness 3 mm, width 1 cm, length 3.5 cm). The adhesive bonding is achieved with Tesa® 4965. The polyimide foil is then looped around the polycarbonate sheet and adhesive-bonded at a distance of 20 mm from the end, by using the heat-activatable foil. The width of the heat-activatable foil for the adhesive bonding process is 10 mm and its length is 3 mm. After the adhesive bonding process, the composite is stored in an oven at 85° C. or at −40° C. The test is passed if separation of the adhesive bond due to the flexural stiffness of the polyimide foil is reliably prevented over a period of 72 hours.

### 90° Bond Strength Test B

The heat-activatable foil is used for adhesive bonding of a strip of polyimide foil of width 1 cm, thickness 100 μm and length 10 cm to a polycarbonate sheet of thickness 3 mm, width 5 cm and length 20 cm.

A tensile testing machine from Zwick is then used to peel the polyimide foil at a velocity of 50 mm/min at a constant tension angle of 90°, and the force is measured in N/cm. The measurement is made at 23° C. with 50% humidity. Three measurements are made and the values are averaged.

### Rheology Test C

The measurement was made with a rheometer from Rheometrics Dynamic Systems (RDA II). The diameter of the specimen was 8 mm, and the thickness of the specimen was from 1 to 2 mm. Plate-on-plate configuration was used for the measurement. Temperature sweep from 0 to 150° C. with frequency 10 rad/s was selected. The rheology of the thermoplastics was measured, and the crossover point was determined.

### Adhesive Bonding

The adhesive bonding of the thermoplastic heat-activatable foils was carried out in a heated press with ram temperature 150° C., contact time 10 sec., and a pressure of 5 bar, based on the adhesive bonding area.

### Reference Example 1

Dynapol® S EP 1408 (copolyester from Evonik, melting point 80° C.) was pressed at 140° C. to 100 μm between two layers of siliconized glassine release paper. The crossover determined by test method C was at 91° C.

### Reference Example 2

Dynapol® S 361 (copolyester from Evonik, melting point 175° C.) was pressed at 230° C. to 100 μm between two layers of siliconized glassine release paper. The crossover determined by test method C was at 178° C.

### Reference Example 3

Tesa® 4982 (thickness 100 μm, 12 μm PET backing, resin-modified pressure-sensitive acrylate mass, 2×46 g/m²) was tested concomitantly as pressure-sensitive adhesive mass. The product was applied at 23° C., but with use of a pressure of 5 bar, and an adhesive bonding time of 10 sec.

### Example 1

Dynapol® S 1218 (copolyester from Evonik, melting point 115° C.) was pressed at 160° C. to 100 μm between two layers of siliconized glassine release paper. The crossover determined by test method C was at 110° C.

### Example 2

Vestamelt® 470 AG (copolyamide from Evonik Degussa, melting point 112° C.) was pressed at 160° C. to 100 μm between two layers of siliconized glassine release paper. The crossover determined by test method C was at 108° C.

### Results:

Repulsion test A was first carried out with all of the examples. Table 1 shows the results.

TABLE 1

| | Repulsion test A | | Repulsion test A |
|---|---|---|---|
| Examples | (85° C.) | | (−40° C.) |
| 1 | >72 | hours | >72 hours |
| 2 | >72 | hours | >72 hours |
| Reference 1 | 6 | hours** | >72 hours |
| Reference 2 | not determined* | | not determined* |
| Reference 3 | 2 | hours** | >72 hours |

*Heat-activatable foil could not be melted.
**The adhesive bond separated within this period

The results provide evidence that the heat-activatable examples 1 to 2 can achieve very good repulsion resistance at 85° C. and at −40° C. In all cases, the adhesive bond held for more than 72 hours. In contrast, reference example 3 provides evidence that pressure-sensitive adhesive masses do not have very good suitability. Here, the adhesive bond separated within as little as 2 hours at 85° C. Reference example 2 could not be melted under the standard conditions. Melting was achieved only after the temperature had been increased to 210° C. However, at this temperature the polycarbonate had already begun to deform, and said thermoplastic cannot therefore be applied without damaging the substrates. Reference example 1 here exhibited markedly easier melting, but the adhesive bond separated at 85° C. after as little as 6 hours. The thermoplastic is too soft for this application.

In another test, adhesive bond strength was determined by test method B. Table 2 collates the results.

TABLE 2

| Examples | 90° bond strength test B |
|---|---|
| 1 | 19.0 N/cm |
| 2 | 20.3 N/cm |
| Reference 1 | 17.4 N/cm |
| Reference 2 | not determined* |
| Reference 3 | 7.2 N/cm |

*Heat-activatable foil could not be melted.

The values in Table 2 provide evidence that all of the examples 1 to 2 of the invention achieved very high adhesive bond strengths and therefore that very good adhesion was provided to polyimide and polycarbonate. Reference example 3 illustrates that markedly smaller adhesive bond strengths are achieved with pressure-sensitive adhesive masses. Reference example 2 could not be melted under the standard conditions. Melting was achieved only after the temperature had been increased to 210° C. However, at this temperature the polycarbonate had already begun to deform, and said thermoplastic cannot therefore be applied without damaging the substrates.

The measured values show that all of the examples of the invention comply with the most important criteria for adhesive bonding of a flexible circuit board. The examples of the invention therefore have very good suitability for said application.

We claim:

1. A process for the adhesive bonding of two plastics surfaces to one another, where the adhesive bonding is brought about via a heat-activatable adhesive mass, wherein
the heat-activatable adhesive mass used comprises one based on
i) at least one thermoplastic with a softening point or melting point in the range from 90 to 120° C.,
where
at least one of the plastics surfaces requiring adhesive bonding belongs to a substrate which has a thermal conductivity sufficiently large to transmit activation energy needed for the adhesive bonding process to the heat-activatable adhesive mass.

2. The process according to claim 1, wherein the adhesive mass comprises
ii) up to 20% by weight of one or more tackifying resins,
and/or
iii) up to 30% by weight of one or more reactive resins.

3. The process according to claim 1, wherein one of the plastics surfaces requiring adhesive bonding belongs to a flexible circuit board.

4. The process according to claim 3, wherein the flexible circuit board has a bending angle of at least 90°.

5. The process according to claim 1, wherein the at least one thermoplastic is selected from the group consisting of polyurethanes, polyesters, polyamides, ethylene-vinyl acetates, copolyamides, copolyesters, and polyolefins.

6. The process according to claim 2, wherein at least one reactive resin cis selected from the group of the reactive resins comprising phenolic resins, epoxy resins, melamine resins, and novolak resins.

7. The process according to claim 1, wherein transmission of the activation energy for the adhesive bonding process, and the adhesive bonding process, take place over a period of at most 15 seconds.

8. An adhesive bond obtainable by the process according to claim 1.

9. The process according to claim 4, wherein the bending angle is 180°.

10. The process according to claim 7, wherein the period is at most 5 seconds.
